(19) United States
(12) Patent Application Publication
(10) Pub. No.: US 2008/0222563 A1
(43) Pub. Date: Sep. 11, 2008

(54) Method and System for Providing Machine-Readable News content

(76) Inventor: Robert D. Prinsky, Brooklyn, NY (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/682,876

(22) Filed: Mar. 6, 2007

(51) Int. Cl. G06F 3/048

(52) U.S. Cl. 715/810

(57) ABSTRACT

The present invention relates generally to a method and system for providing machine-readable news content to potential users of such information. More specifically, the present invention relates to a method and system for selecting news content, entering it into a computer file, converting it to a machine-readable format, and providing the resulting machine-readable data to potential users of the news content.

### CROSS REFERENCE TO RELATED APPLICATION(S)

None.

### FIELD OF THE INVENTION

The present invention relates generally to a method and system for providing machine-readable news content to potential users of such information. More specifically, the present invention relates to a method and system for selecting relevant news content to deliver to potential users, entering discrete pieces of news of interest into an input device, translating such news content into machine-readable format, and delivering such news content to the potential users.

### BACKGROUND OF THE INVENTION

Firms and institutions that trade in financial securities have begun to use automated trading systems. Trading systems are sets of rules that traders use to determine when to buy or sell securities. Automated trading systems convert those rules into computer code usable by trading software. The algorithms of such systems then recognize situations that call for the purchase or sale of securities under the trading system, and place the appropriate transactions automatically without human intervention or assistance. Automated trading systems thus enable traders to recognize and act very quickly on new information.

Rapid reporting of financial information, such as key economic indicators and corporate earnings and action information, is essential to firms and institutions that trade in financial securities. Traditional reporting of such news, however, which is based on a free text format, is easily read by humans but is not easily processed by computers or computer algorithms. Therefore, text-based news content is not readily usable by automated trading systems. Such systems require a more structured type of input from which their software applications can quickly and reliably extract essential content and meaning.

Thus, there is a need in the art for a system and method to publish news content in a machine-readable format and deliver it to potential users of such information.

### BRIEF SUMMARY OF THE INVENTION

The present invention relates generally to a method and system for providing machine-readable news content to potential users of such information. One embodiment of the present invention is a process for providing machine-readable news content to potential users of such content. In this embodiment, an operator selects news content to provide, enters elements of the selected news content into a computer file via a graphical user interface, uses a computer program to generate a news message in machine-readable format using the entered elements, and electronically delivers the news message in machine-readable format to a potential user of such news content.

In another embodiment of the present invention, the process for providing machine-readable news content to potential users of such information includes selecting news content to provide, entering elements of the selected news content into a computer file via a graphical user interface, using a computer program to generate a news message in machine-readable format using the entered elements, using a computer program to generate a news message in free-text format using the entered elements, delivering the news message in machine-readable format to potential users of such news content, and delivering the news message in free-text format to potential users of such news content.

In yet another embodiment, the present invention is a system for providing machine-readable news content comprising a computer including a display and an input device, a computer program capable of presenting a graphical user interface to an operator, such graphical user interface enabling the operator to enter elements of news content into a computer file, a computer program capable of generating a news message in machine-readable format using the entered elements, and means for electronically providing such news messages in machine-readable format to potential users.

In yet another embodiment, the present invention is a computerized method for delivering machine readable news, comprising receiving news content at a computer, generating a news message in machine readable format based at least in part on the received news content, and transmitting at least a portion of the generated news message in machine-readable format to a third party.

In yet another embodiment, the present invention is software for delivering news message in machine-readable format, comprising computer instructions configured to cause a computer to receive news content, computer instructions configured to cause a computer to generate a news message in machine-readable format based at least in part on the received news content, and means for transmitting at least a portion of the generated news message in machine-readable format to a third party.

In yet another embodiment, the present invention is software for delivering news message in machine-readable format, comprising computer instructions configured to cause a computer to receive news content, computer instructions configured to cause a computer to generate a news message in machine-readable format based at least in part on the received news content, and computer instructions configured to cause a computer to transmit at least a portion of the generated machine readable news to a third party.

In yet another embodiment, the present invention is a process for providing machine-readable news content comprising a graphical user interface receiving news content from an operator, the graphical user interface generating a news message in machine-readable format upon receiving an instruction from the operator, and electronically delivering the news message in machine-readable format to a potential user of such news content.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 illustrates a flow chart of a method for providing machine-readable news content to potential users of such information in accordance with one embodiment of the present invention.

FIG. 2 illustrates a flow chart of a method for providing machine-readable news content to potential users of such information in accordance with one embodiment of the present invention.

FIG. 3 illustrates a flow chart of a method for providing machine-readable news content to potential users of such information in accordance with one embodiment of the present invention.

FIG. 4 illustrates a flow chart of a method for providing machine-readable news content to potential users of such information in accordance with one embodiment of the present invention.

FIGS. 5-40 show flowcharts in accordance with one or more embodiments of the invention.

### DETAILED DESCRIPTION OF THE INVENTION

The present invention relates generally to a method and system for providing machine-readable news content to potential users of such information. More specifically, the present invention relates to a method and system for selecting news content, entering it into a computer file, converting it to a machine-readable format, and providing the resulting machine-readable data to potential users of the news content.

In use, an operator of the system or user of the method selects news content that may be of interest to financial traders such as economic indicators or corporate actions. The operator then uses a computer with an interface that enables him or her to enter news content of interest into the computer interface. The operator selects relevant, discrete pieces of news to enter. Depending on the category of news event, the computer program will prompt the operator to enter specific news items into fields identified by the interface. The computer program then translates the news items entered by the operator into a machine-readable format. In this way, the news content is elementized and rendered machine-readable. The operator then delivers the machine-readable news content to potential users via traditional means such as a network or low latency feed. In addition, the operator may deliver the same news in free text format to the same or other potential users via such traditional means.

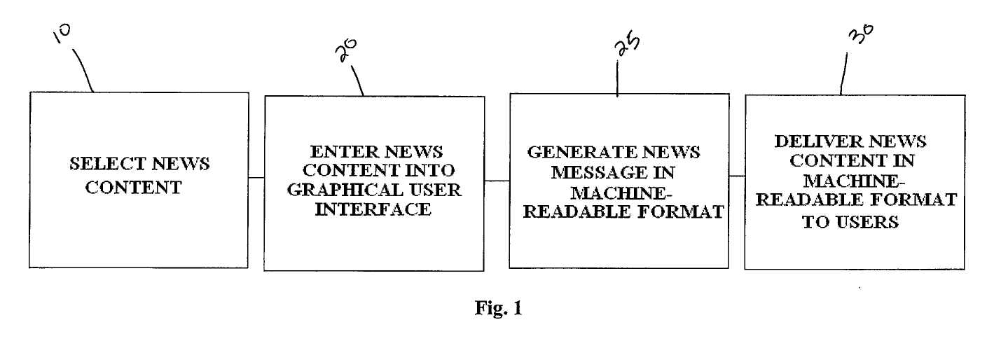

FIGS. 1-4 show flowcharts of methods for providing machine-readable news content to potential users of such information in accordance with one or more embodiments of the intention. While the various steps in these flowcharts are presented and described sequentially, one of ordinary skill will appreciate that some or all of the steps may be executed in different orders or in parallel.

FIG. 1 illustrates a flowchart of one embodiment of the method of the present invention. Each of the blocks is explained more fully below. At block 10, the operator of the system selects news content that may be of interest to financial traders. Such news content may take the form of press releases, wire service items, articles, or other formats. It may be in electronic format, paper format, or received orally. Relevant news content is anything that may be of interest to traders in financial securities. For example, such news content may include economic indicators for the United States or other countries. There are numerous economic indicators published by the United States Department of Labor, the United States Department of Commerce, and other agencies and entities both in the United States and in other countries. These include, by way of example, the U.S. Consumer Price Index, U.S. Employment, U.S. Productivity, Existing Home Sales, and Consumer Credit. Further, relevant news content may include information concerning actions of corporations in the United States or other countries. Such corporate actions may include, by way of example, the reporting of corporate earnings, corporate outlook or guidance reports, analyst actions, corporate ratings, restatements or accounting reports, or mergers and acquisitions. Further, relevant news content may include capital market news, such as news concerning the United States Treasury Department or the Finance Ministries of other countries.

After selecting news content of interest, the operator of the system enters data elements of interest from the news content into a computer file via a graphical user interface at block 20. The graphical user interface is generated by a computer software program. The interface is shown on a display device, such as a computer monitor. The operator of the system may enter news items of interest via an input device, such as a keyboard.

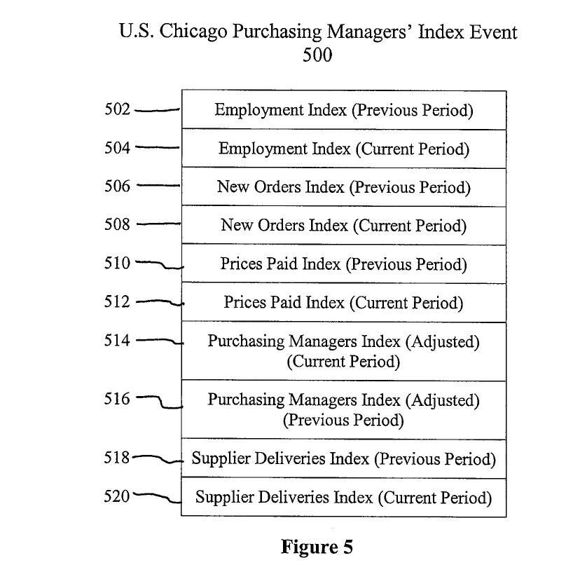

To enter the news content, the operator first identifies the relevant elements of the news content. In certain embodiments, the computer program prompts the operator for specific elements in response to the operator's identification of a news item, such as an economic indicator or corporate action. Data elements that will be included in elementized news messages include, by way of example, the country or region of origin, the company ticker, the event type, the time period or date, the element name, and the element value. It is expected that each type of event, such as an economic indicator or corporate action, will have associated with it specific data elements. For example, economic indicators may include the date, the particular economic indicator to be reported, the numerical value reported by the agency, any prior estimates of the particular economic indicator, and the difference between the economic indicator reported and prior estimates. Similarly, corporate actions, such as the reporting of corporate earnings, will have specific data elements associated with them. For example, a corporate earnings report may call for the date, the numerical value of the earnings reported, and any prior estimates of that company's expected earnings. The data elements of interest for news events are described in more detail below in the discussion of FIGS. 5-40.

When the operator enters the news content into the graphical user interface, the system converts the content into a machine-readable format and generates a news message in machine-readable format at box 25. In some embodiments of the invention, the machine-readable news message is constructed using Extensible Markup Language (XML). Samples of the output of the system in XML format for certain economic indicator events and corporate action events is shown in Appendix 1. The graphical user interface is configured in such a way to receive data elements entered by the operator as set forth in Appendix 1.

At block 30, the news message in machine-readable format is delivered to potential users of such information. In some embodiments, persons or firms who wish to receive such messages subscribe to a service and such messages are sent automatically to all subscribers. In other embodiments, the subscribers or users may specify the types of news messages they wish to receive, and the system will send to such subscribers only the messages that meet the criteria identified by the subscriber. Typically, the transmission of data occurs over directly wired connections (“ultra low latency feed”) to customers. More specifically, in one embodiment, the news content is made available to subscribers via one or more communication protocols, such as HyperText Transfer Protocol (HTTP), Transmission Control Protocol (TCP), and Internet Protocol (IP), with the connection initiated from the news content provider's servers. Accordingly, subscribers' systems are required to maintain active sockets to receive connection requests from the new content provider's servers. A configuration will use, for example, a well-connected TCP session, optimized to reduce latency. In other embodiments, the transmission of the messages may occur over a network, such as a wide area network (WAN) like the internet, a wireless network, a local area network (LAN), or a combination of networks.

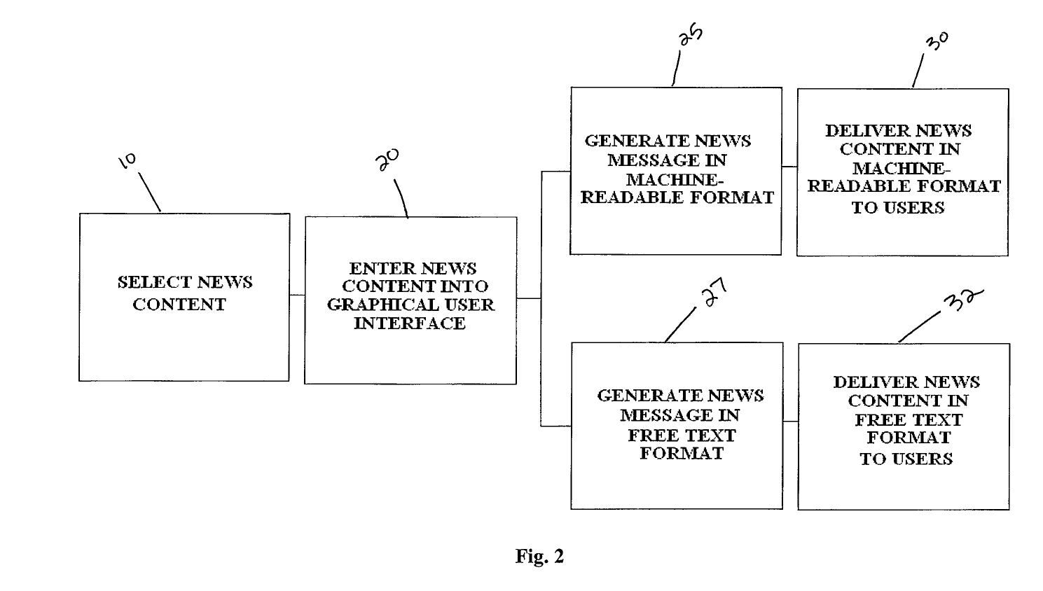

FIG. 2 illustrates a flowchart of an embodiment of the method of the present invention in which the system generates a text-based news message, in addition to a machine-readable message, based upon the data elements entered by the operator. At block 10, the operator of the system selects news content that may be of interest to financial traders. At block 20, the operator enters relevant, discrete pieces of news content into the computer interface.

At block 25, the system converts the content into a machine-readable format and generates a news message in machine-readable format. At the same time, in block 27, the system generates a news message in free text format. For example, the system may include a generic text-based news message for corporate earnings reports, which incorporates standard text with blanks for the report-specific elements such as company name, date, and earnings reported. After the operator enters the relevant data, the system will incorporate the elements entered by the operator into the generic text news message, thereby creating a free text version of the news content. In some embodiments, the operator will be able to then modify the text message, although he or she may not be able to change the order of the elements. Either way, in this embodiment, the operator can publish and deliver both a free text message and a machine-readable message simultaneously.

In embodiments in which the system also generates a text-based news message, the system may also deliver that text-based message to users over the same or other networks or connections in box 32. The text-based messages may be delivered to the same or different recipients. In some embodiments, the free text message and the machine-readable message are sent at the same time and in the same way. In other embodiments, the machine-readable message may be sent via a high-speed option, such as a low latency feed, while the text message is sent in another way or at another time.

In other embodiments, the financial news content may not be made immediately available to subscribers. For example, on occasion, financial news content providers receive information that cannot be published until some specified time. In such cases, the news content may be prepared in advance and held in the system for transmission at the specified time.

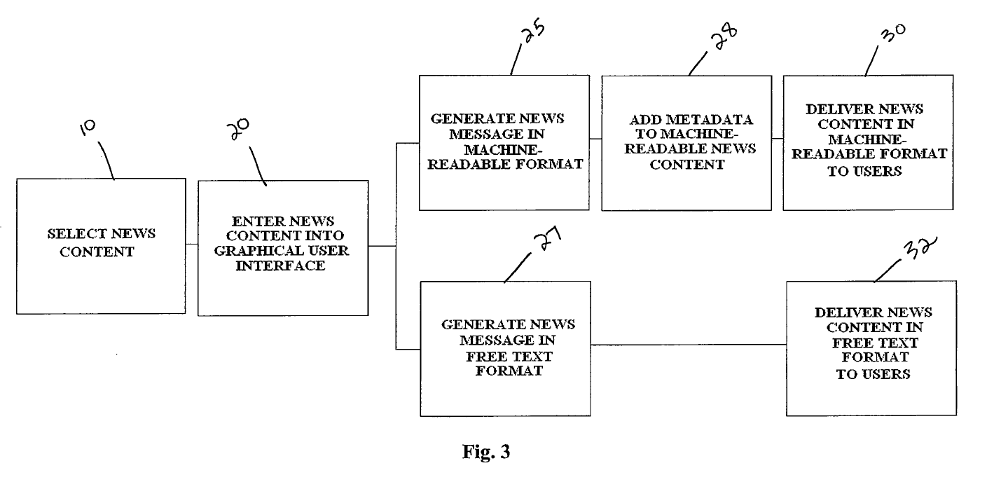

FIG. 3 illustrates a flowchart of another embodiment of the method of the present invention. At block 10, the operator of the system selects news content that may be of interest to financial traders. At block 20, the operator enters relevant, discrete pieces of news content into the graphical user interface. Typically, the software guides the operator as to the discrete pieces of news content that need to be provided. In one embodiment, a graphical user interface may be used to receive the information for a particular category of news content. At block 25, the system uses the news content to generate a news message in machine-readable format. At block 27, the system uses the news content to generate a news message in free text format.

At block 28, the operator of the system adds metadata tags to the elementized, machine-readable message. Through the use of metadata, the operator can provide additional information that may be usable by an algorithmic trading system. For example, the operator may be able to identify the significance or importance of the news content to the company at issue through the use of a metadata tag identifying the content as of high, medium, low, or don't know significance. Other metadata tags may include the age of the news item (such as new or update), schedule status (scheduled or unscheduled event), surprise status (above or below expectations), and red or yellow flag (identifying anomalous data). After adding metadata tags, the operator at blocks 30 and 32 delivers the news message in machine-readable and free text formats, respectively, to their recipients. In one or more embodiments of the invention, the metadata tags are predefined and appear in the graphical user interface as options that the operator may select. Those metadata tags that the operator selects will be encoded in the machine-readable XML output.

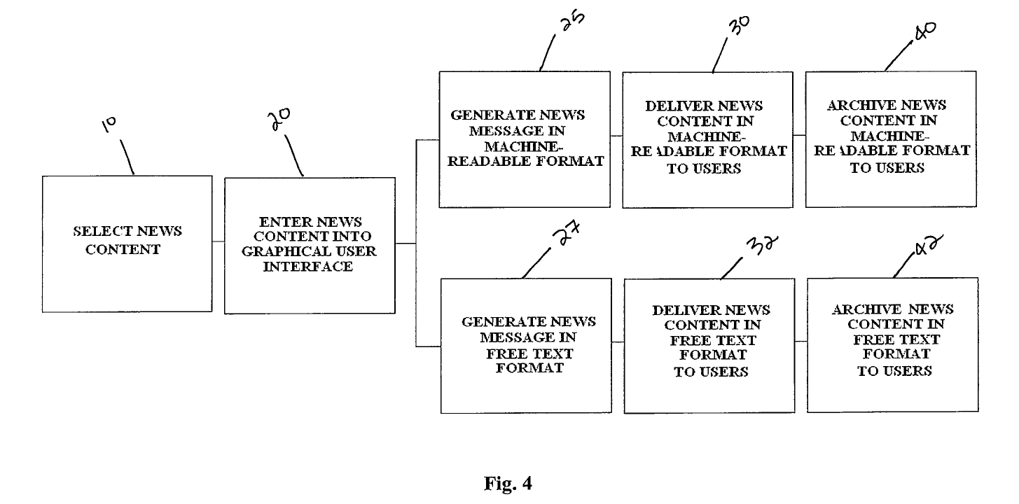

FIG. 4 illustrates a flowchart of another embodiment of the method of the present invention. At block 10, the operator of the system selects news content. At blocks 20, 25, and 27, the operator enters the relevant elements of the news content into the system and the system generates news messages in machine-readable format and free-text format. At blocks 30 and 32, the system delivers the news messages in machine-readable and free text formats to their recipients. At block 40, the system archives the machine-readable news message. At block 42, the system archives the free text format news message. The system may use the archived news items to provide information for future messages, such as reporting a change in earnings. Furthermore, the archives may be made available to users or subscribers of the system for historical information.

In a particular embodiment, the archived content, in addition to published financial news content, includes financial news content derived from a pre-existing database that comprises financial news content for a specified preceding period. In a specific embodiment, the archived content includes financial news content for the preceding two years. The archived news content may be used by subscribers for any useful purpose. For example, subscribers may use the archived financial news content to evaluate the effectiveness of existing algorithmic trading programs.

As described above, in one or more embodiments of the invention, the computer program prompts the operator for specific data elements to enter. Such data elements are predefined in the computer program. Each category of news item, such as a specific economic indicator or a corporate action such as a corporate earnings report, will have data elements associated with it which the computer program will prompt the user to enter. Economic indicators and corporate events can pertain to any country or region in the world that produces such information, including the United States, the European Union, Australia, and individual countries in Europe, Asia, North or South America, or Africa. Certain data elements will have application across a broad range of news item categories, while others will be specific to particular news item categories. These data elements define the information that the operator will be prompted to enter and which they system will then use to create both the free-text and machine-readable news messages.

In these embodiments, after the operator identifies the category of news item to be entered, the computer program will display via the graphical user interface prompts to enter the specific data elements associated with that category of news item. The operator identifies and enters the data elements as prompted to the extent such information can be located or was provided. However, if a particular news source has no data corresponding to a requested data element, the operator need not enter anything for that element and the program will encode it as a null value. Furthermore, in some embodiments, the computer program enables the operator to input news data elements separate and apart from the predefined data elements should the operator identify in the news source other items of interest.

FIGS. 5-40 illustrate the data elements defined in the computer program in accordance with one or more embodiments of the invention. It will be understood by those of skill that the particular list of data elements associated with a given news item category may change over time, depending upon the information typically reported and changes to news of interest to traders in securities. Further, unless specifically otherwise described, each data value in the described data structures may be in any representation suitable for representing the value. For example, an identifier may be string, an integer, a name, or any other suitable value.

FIGS. 5-38 illustrate the data elements associated with economic indicators reported for the United States. It is understood that appropriate data elements may also be identified for similar or different economic indicators for any other region or country in the world. For example, Canada, the European Community, and individual European and Asian countries may report some or all of the same types of economic indicators described and shown in FIGS. 5-38. For such economic indicators, the same or similar data elements will be identified and predefined within the system.

FIG. 5 shows the data elements for the economic indicator “Chicago Purchasing Managers' Index” event (500) in accordance with one or more embodiments of the invention. The data elements associated with this economic indicator event include the Employment Index for the current and previous periods (502, 504); the New Orders Index for the current and previous periods (506, 508); the Prices Paid Index for the current and previous periods (510, 512); the Adjusted Purchasing Managers Index for the current and previous periods (514, 516); and the Supplier Deliveries Index for the current and previous periods (518, 520).

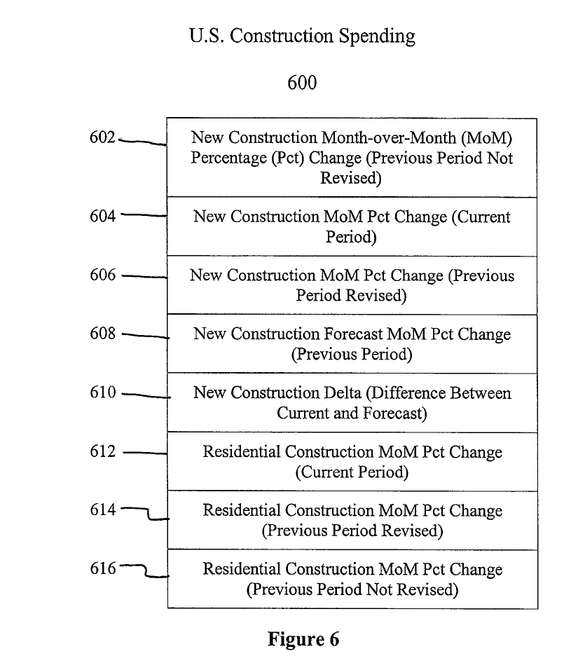

FIG. 6 shows the data elements for the economic indicator “U.S. Construction Spending” event (600) in accordance with one or more embodiments of the invention. The data elements associated with this economic indicator event include New Construction Month-over-Month Percentage Change for the current period and both unrevised and revised figures for the previous period (602, 604, 606); the forecast for the New Construction Month-over-Month Percentage Change for the current period (608); the difference between the forecast and the current data for the New Construction Month-over-Month Percentage Change (610); and Residential Construction Month-over-Month Percentage Change for the current period and both unrevised and revised figures for the previous period (612, 614, 616).

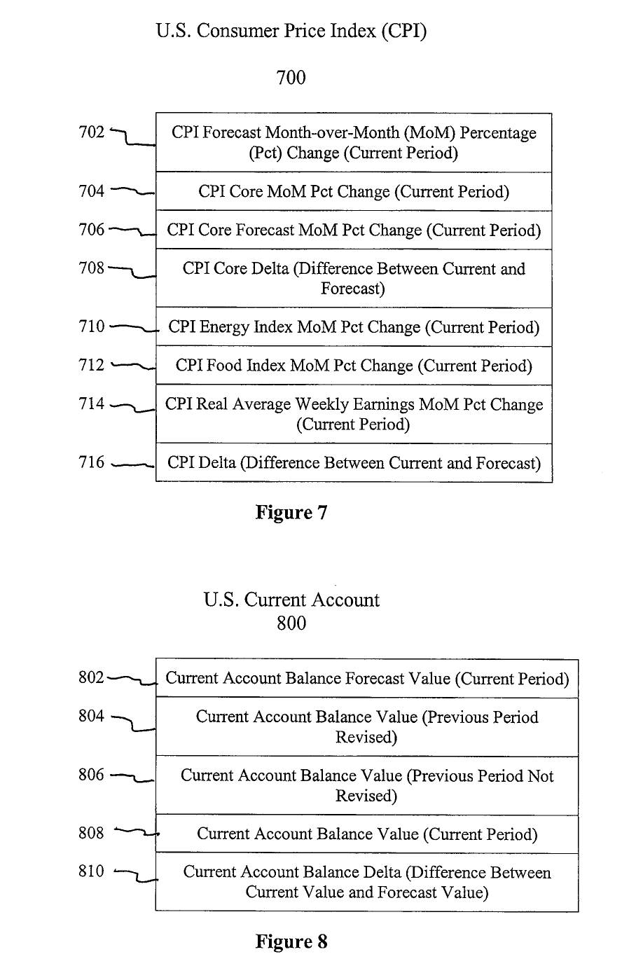

FIG. 7 shows the data elements for the economic indicator “U.S. Consumer Price Index” event (700) in accordance with one or more embodiments of the invention. The data elements associated with this economic indicator event include the forecast for the Consumer Price Index (“CPI”) Month-over-Month Percentage Change (702); the forecast and current data for the CPI Core Month-over-Month Percentage Change, as well as the difference between those two figures (704, 706, 708); the CPI Energy Index Month-over-Month Percentage Change for the current period (710); the CPI Food Index Month-over-Month Percentage Change for the current period (712); the CPI Real Average Weekly Earnings Month-over-Month Percentage Change for the current period (714); and the difference between the forecast and current figure of the CPI (716).

FIG. 8 shows the data elements for the economic indicator “U.S. Current Account” event (800) in accordance with one or more embodiments of the invention. The data elements associated with this economic indicator event include the U.S. Current Account Balance for the current period as well as both revised and unrevised figures for the previous period (804, 806, 808); the forecast of the Current Account Balance for the current period (802); and the difference between the forecast and current figures of the Current Account Balance (810).

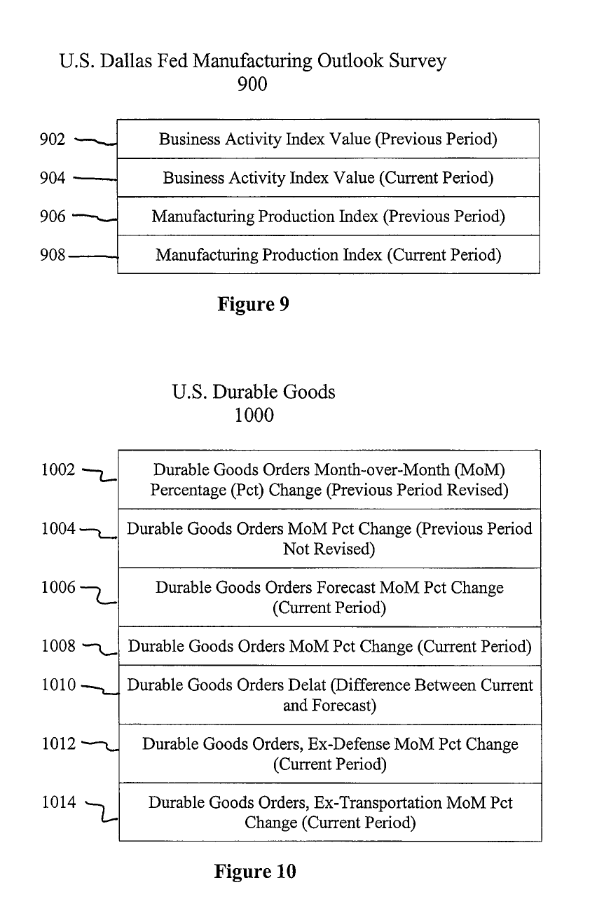

FIG. 9 shows the data elements for the economic indicator “Dallas Fed Manufacturing Outlook Survey” event (900) in accordance with one or more embodiments of the invention. The data elements associated with this economic indicator event include the Business Activity Index for the current and previous periods (902, 904) and the Manufacturing Production Index for the current and previous periods (906, 908).

FIG. 10 shows the data elements for the economic indicator “U.S. Durable Goods” event (1000) in accordance with one or more embodiments of the invention. The data elements associated with this economic indicator event include the Month-over-Month Percentage Change in Durable Goods Orders for the current period as well as both unrevised and revised figures for the previous period (1002, 1004, 1008); the forecast for the Month-over-Month Percentage Change in Durable Goods Orders for the current period (1006); the difference between the forecast and current figures for the Month-over-Month Percentage Change in Durable Goods Orders (1010); the Month-over-Month Percentage Change in Durable Goods Orders excluding defense orders (1012); and the Month-over-Month Percentage Change in Durable Goods Orders excluding transportation orders (1014).

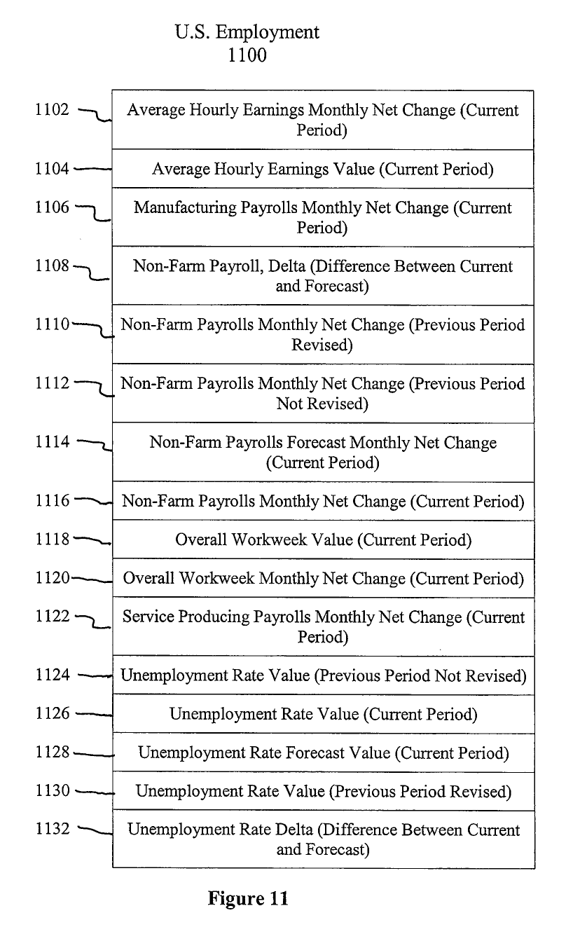

FIG. 11 shows the data elements for the economic indicator “U.S. Employment” event (1100) in accordance with one or more embodiments of the invention. The data elements associated with this economic indicator event include the Average Hourly Earnings and Average Hourly Earnings Monthly Net Change for the current period (1102, 1104); the monthly net change in Manufacturing Payrolls for the current period (1106); the monthly net change in Non-Farm Payrolls for the current period as well as both unrevised and revised figures for the previous period (1110, 1112, 1116); the forecast for the monthly net change in Non-Farm Payrolls for the current period (1114); the difference between the forecast and current figures for the monthly net change in Non-Farm Payrolls (1108); the Overall Workweek and Overall Workweek Monthly Net Change for the current period (1118, 1120); the monthly net change in Service Producing Payrolls for the current period (1122); the Unemployment Rate for the current period as well as both unrevised and revised figures for the previous period (1124, 1126, 1130); the forecast for the Unemployment Rate for the current period (1128); and the difference between the current and estimated figures for the Unemployment Rate (1128, 1132).

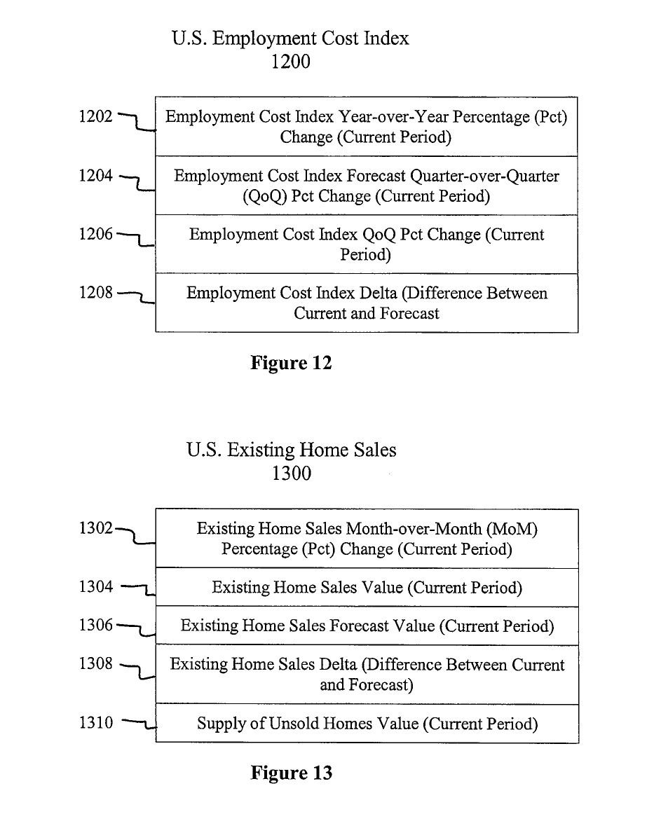

FIG. 12 shows the data elements for the economic indicator “U.S. Employment Cost Index” event (1200) in accordance with one or more embodiments of the invention. The data elements associated with this economic indicator event include the Year-over-Year and Quarter-over-Quarter Percentage Change in the Employment Cost Index for the current period (1202, 1206); the forecast for the Quarter-over-Quarter Percentage Change in the Employment Cost Index for the current period (1204); and the difference between the forecast and current figures for the Employment Cost Index for the current period (1208).

FIG. 13 shows the data elements for the economic indicator “U.S. Existing Home Sales” event (1300) in accordance with one or more embodiments of the invention. The data elements associated with this economic indicator event include the Month-over-Month Percentage Change in Existing Home Sales for the current period (1302); Existing Home Sales for the current period (1304); the forecast of Existing Home Sales for the current period (1306); the difference between the current and forecast figures for Existing Home Sales for the current period (1308); and the Supply of Unsold Homes for the current period (1310).

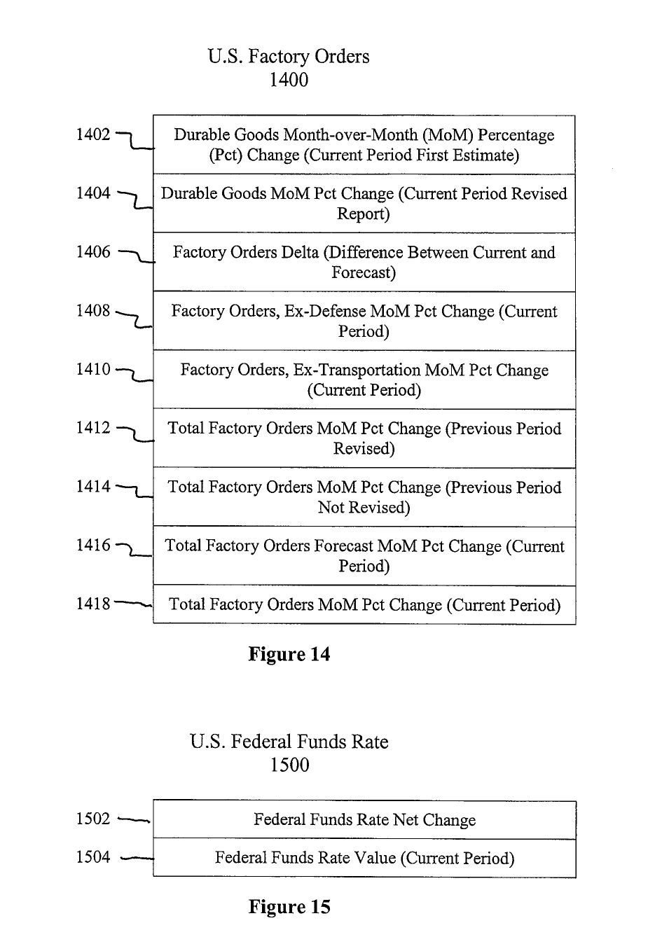

FIG. 14 shows the data elements for the economic indicator “U.S. Factory Orders” event (1400) in accordance with one or more embodiments of the invention. The data elements associated with this economic indicator event include both a first estimate and revised report of the Month-over-Month Percentage Change in Durable Goods (1402, 1404); the Month-over-Month Percentage Change in Total Factory Orders for the current period as well as unrevised and revised figures for the previous period (1412, 1414, 1418); the forecast of Month-over-Month Percentage Change in Total Factory Orders for the current period (1416); the difference between the forecast and current figures for Total Factory Orders for the current period (1406); the Month-over-Month Percentage Change in Factory Orders excluding defense orders for the current month (1408); and the Month-over-Month Percentage Change in Factory Orders excluding transportation orders for the current month (1410).

FIG. 15 shows the data elements for the economic indicator “U.S. Federal Funds Rate” event (1500) in accordance with one or more embodiments of the invention. The data elements associated with this economic indicator event include the current period Federal Funds Rate (1504) and the net change in the Federal Funds Rate (1502).

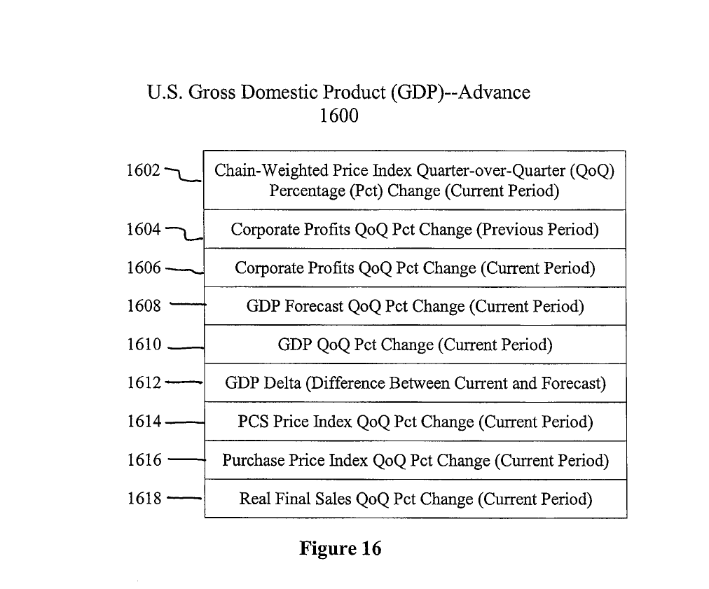

FIG. 16 shows the data elements for the economic indicator “U.S. Gross Domestic Product (GDP)—Advance” event (1600) in accordance with one or more embodiments of the invention. The data elements associated with this economic indicator event include the Quarter-over-Quarter Percentage Change in the Chain-Weighted Price Index for the current period (1602); the Quarter-over-Quarter Percentage Change in Corporate Profits for the current and previous periods (1604, 1606); the Quarter-over-Quarter Percentage Change in the GDP for the current period (1610); the forecast for the Quarter-over-Quarter Percentage Change in the GDP for the current period (1608); the difference between the forecast and current figures for the GDP (1612); the Quarter-over-Quarter Percentage Change in the PCS Price Index for the current period (1614); the Quarter-over-Quarter Percentage Change in the Purchase Price Index for the current period (1616); and the Quarter-over-Quarter Percentage Change in Real Final Sales for the current period (1618).

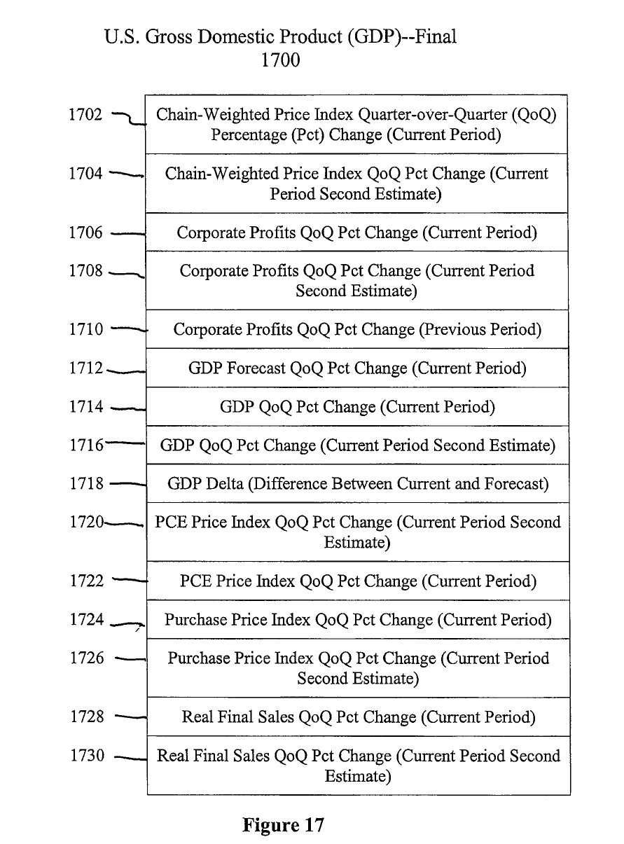

FIG. 17 shows the data elements for the economic indicator “U.S. Gross Domestic Product (GDP)—Final” event (1700) in accordance with one or more embodiments of the invention. The data elements associated with this economic indicator event include the Quarter-over-Quarter Percentage Change in the Chain-Weighted Price Index for the current period as well as the second estimate of that figure (1702, 1704); the Quarter-over-Quarter Percentage Change in Corporate Profits for the current and previous periods as well as the second estimate of that figure for the current period (1706, 1708, 1710); the Quarter-over-Quarter Percentage Change in the GDP for the current period as well as the second estimate of that figure for the current period (1714, 1716); the forecast for the Quarter-over-Quarter Percentage Change in the GDP for the current period (1712); the difference between the forecast and current figures for the GDP (1718); the Quarter-over-Quarter Percentage Change in the PCE Price Index for the current period as well as the second estimate of that figure for the current period (1720, 1722); the Quarter-over-Quarter Percentage Change in the Purchase Price Index for the current period as well as the second estimate of that figure for the current period (1724, 1726); and the Quarter-over-Quarter Percentage Change in Real Final Sales for the current period as well as the second estimate of that figure for the current period (1728, 1730).

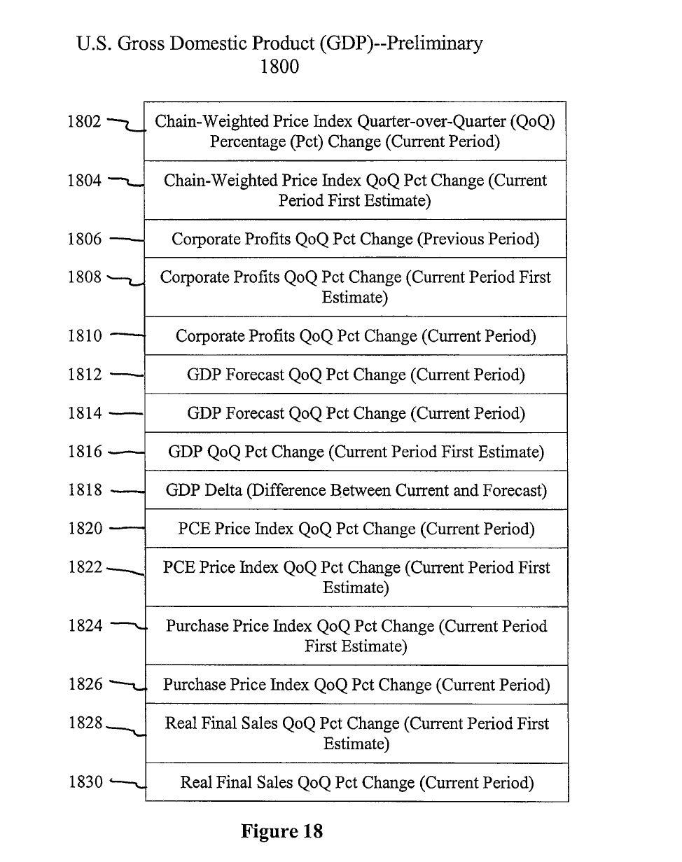

FIG. 18 shows the data elements for the economic indicator “U.S. Gross Domestic Product (GDP)—Preliminary” event (1800) in accordance with one or more embodiments of the invention. The data elements associated with this economic indicator event include the Quarter-over-Quarter Percentage Change in the Chain-Weighted Price Index for the current period as well as the first estimate of that figure (1802, 1804); the Quarter-over-Quarter Percentage Change in Corporate Profits for the current and previous periods as well as the first estimate of that figure for the current period (1806, 1808, 1810); the Quarter-over-Quarter Percentage Change in the GDP for the current period as well as the first estimate of that figure for the current period (1814, 1816); the forecast for the Quarter-over-Quarter Percentage Change in the GDP for the current period (1812); the difference between the forecast and current figures for the GDP (1818); the Quarter-over-Quarter Percentage Change in the PCE Price Index for the current period as well as the first estimate of that figure for the current period (1820, 1822); the Quarter-over-Quarter Percentage Change in the Purchase Price Index for the current period as well as the first estimate of that figure for the current period (1824, 1826); and the Quarter-over-Quarter Percentage Change in Real Final Sales for the current period as well as the first estimate of that figure for the current period (1828, 1830).

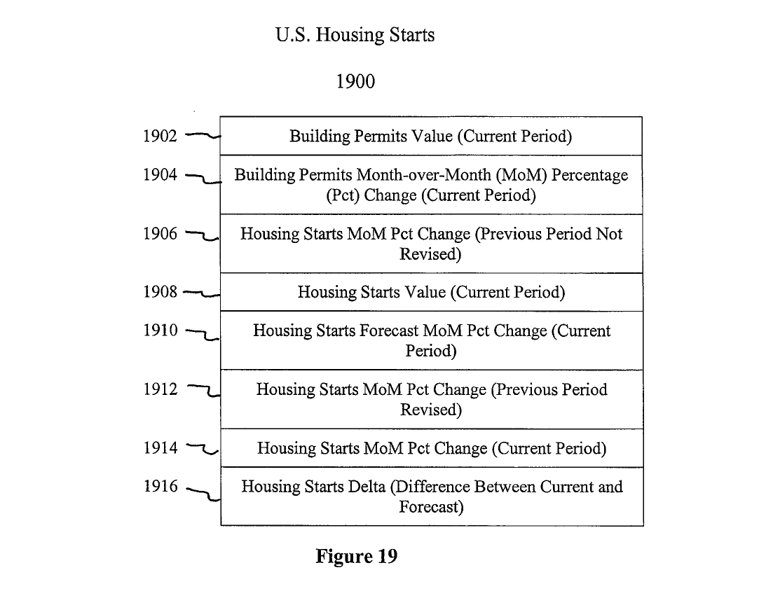

FIG. 19 shows the data elements for the economic indicator “U.S. Housing Starts” event (1900) in accordance with one or more embodiments of the invention. The data elements associated with this economic indicator event include Building Permits for the current period (1902); the Month-over-Month Percentage Change in Building Permits for the current period (1904); Housing Starts for the current period (1908); the Month-over-Month Percentage Change in Housing Starts for the current period as well as unrevised and revised figures for the previous period (1906, 1912, 1914); the forecast for the Month-over-Month Percentage Change in Housing Starts for the current period (1910); and the difference between the forecast and current figures for the Month-over-Month Percentage Change in Housing Starts (1916).

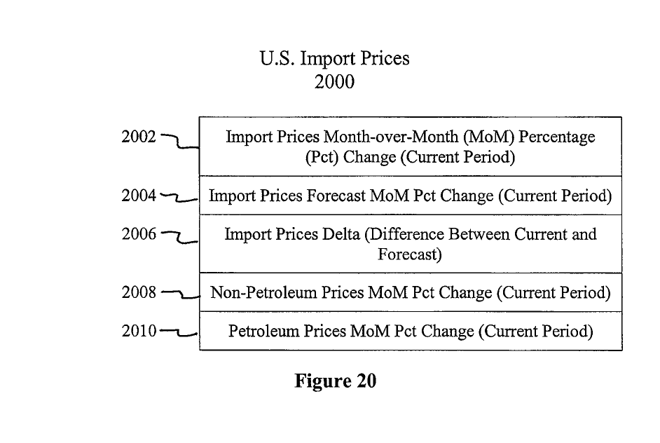

FIG. 20 shows the data elements for the economic indicator “U.S. Import Prices” event (2000) in accordance with one or more embodiments of the invention. The data elements associated with this economic indicator event include the Month-over-Month Percentage Change in Import Prices for the current period (2002); the forecast for the Month-over-Month Percentage Change in Import Prices for the current period (2004); the difference between the current and forecast figures for the Month-over-Month Percentage Change in Import Prices for the current period (2006); the Month-over-Month Percentage Change in Non-Petroleum Prices for the current period (2008); and the Month-over-Month Percentage Change in Petroleum Prices for the current period (2010).

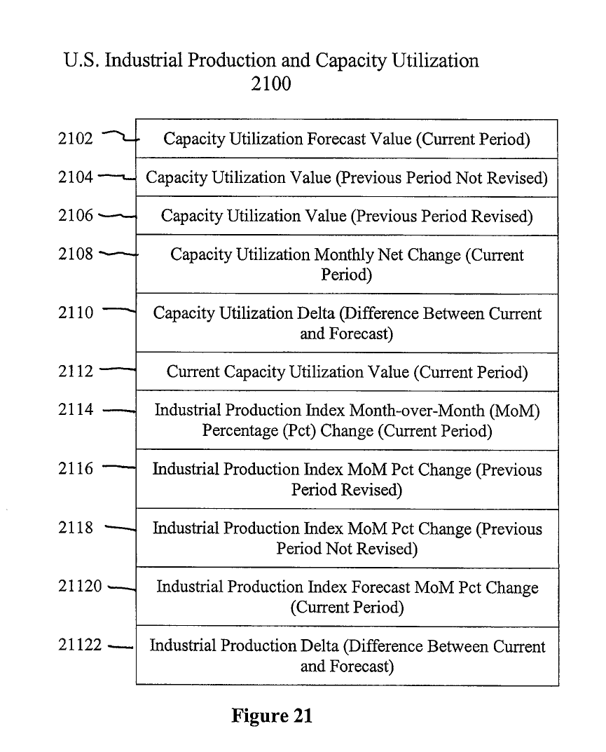

FIG. 21 shows the data elements for the economic indicator “U.S. Industrial Production and Capacity Utilization” event (2100) in accordance with one or more embodiments of the invention. The data elements associated with this economic indicator event include the figures for Capacity Utilization for the current period as well as both unrevised and revised figures for the previous period (2104, 2106, 2112); the forecast for Capacity Utilization for the current period (2102); the monthly net change in Capacity Utilization for the current period (2108); the difference between the forecast and current figure for Capacity Utilization (2110); the Month-over-Month Percentage Change in the Industrial Production Index for the current period as well as both unrevised and revised figures for the previous period (2114, 2116, 2118); the forecast for the Month-over-Month Percentage Change in the Industrial Production Index for the current period (2120); and the difference between the forecast and current figures for the Month-over-Month Percentage Change in the Industrial Production Index for the current period (2122).

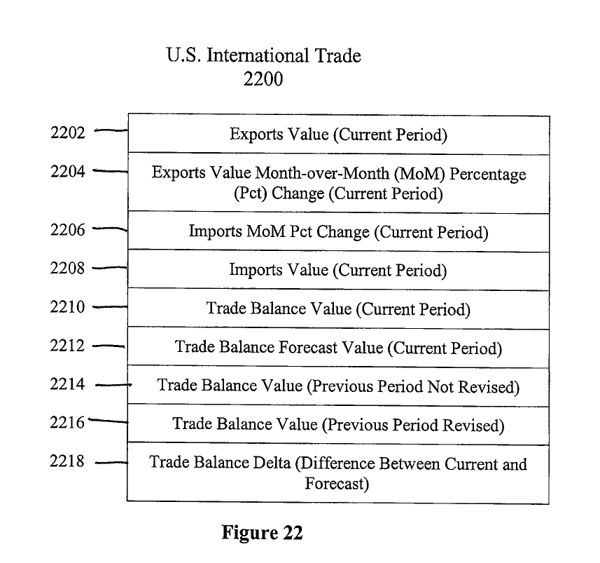

FIG. 22 shows the data elements for the economic indicator “U.S. International Trade” event (2200) in accordance with one or more embodiments of the invention. The data elements associated with this economic indicator event include Exports for the current period (2202); the Month-over-Month Percentage Change in Exports for the current period (2202); Imports for the current period (2208); the Month-over-Month Percentage Change in Imports for the current period (2206); the Trade Balance for the current period as well as both unrevised and revised figures for the previous period (2210; 2214, 2216); the forecast for the Trade Balance for the current period (2212); and the difference between the forecast and current figures for the trade balance for the current period (2218).

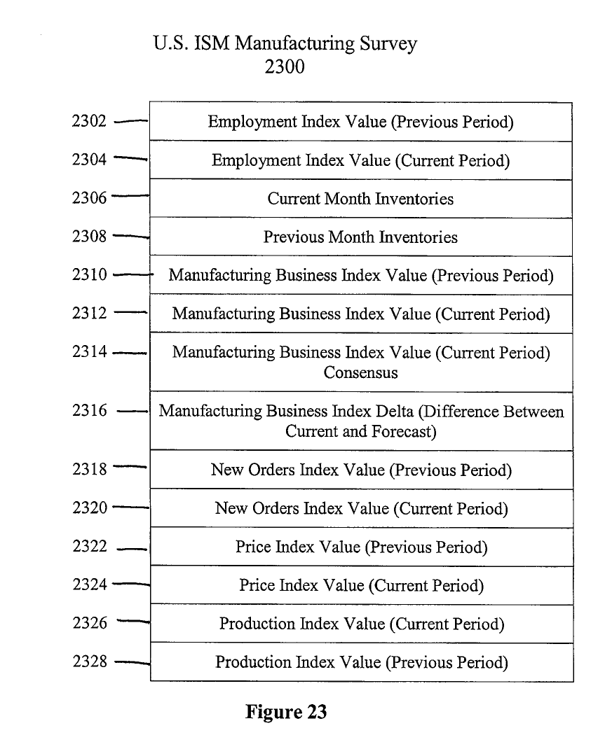

FIG. 23 shows the data elements for the economic indicator “U.S. ISM Manufacturing Survey” event (2300) in accordance with one or more embodiments of the invention. The data elements associated with this economic indicator event include the Employment Index for the current and previous periods (2302, 2304); Inventories for the current and previous periods (2306, 2308); the Manufacturing Business Index for the current and previous periods (2310, 2312); the Consensus for the Manufacturing Business Index for the current period (2314); the difference between the current and consensus figures for the Manufacturing Business Index for the current period (2316); New Orders Index for the current and previous periods (2318, 2320); the Price Index for the current and previous periods (2322, 2324); and the Production Index for the current and previous periods (2326, 2328).

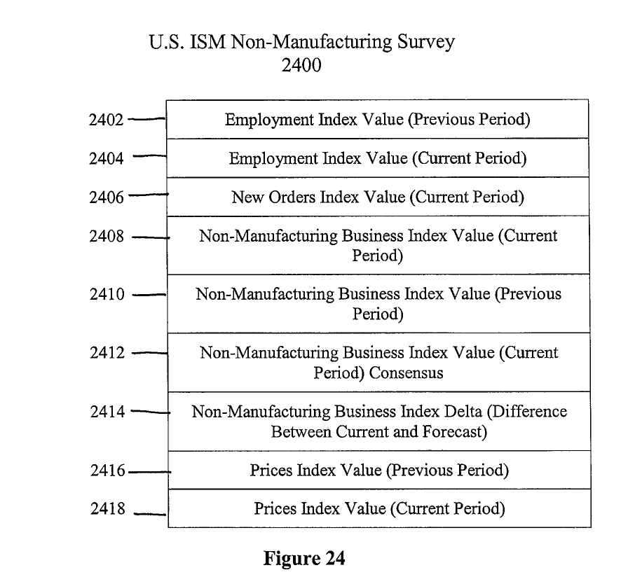

FIG. 24 shows the data elements for the economic indicator “U.S. ISM Non-Manufacturing Survey” event (2400) in accordance with one or more embodiments of the invention. The data elements associated with this economic indicator event include the Employment Index for the current and previous periods (2402, 2404); the Non-Manufacturing Business Index for the current and previous periods (2408, 2410); the Consensus for the Non-Manufacturing Business Index for the current period (2412); the difference between the current and consensus figures for the Non-Manufacturing Business Index for the current period (2414); New Orders Index for the current period (2406); and the Price Index for the current and previous periods (2416, 2418).

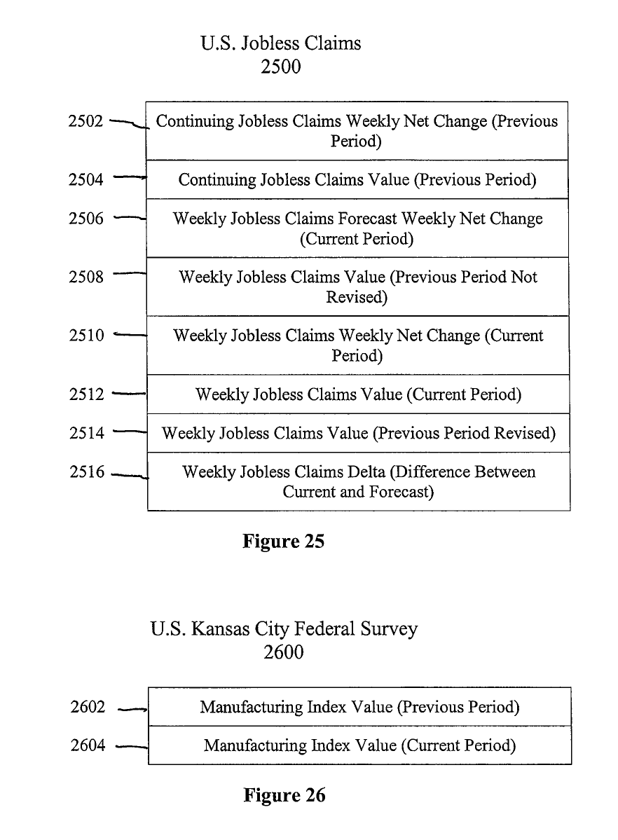

FIG. 25 shows the data elements for the economic indicator “U.S. ISM Jobless Claims” event (2500) in accordance with one or more embodiments of the invention. The data elements associated with this economic indicator event include the Continuing Jobless Claims for the current period (2504); the weekly net change in the Continuing Jobless Claims for the previous period (2502); Weekly Jobless Claims for the current period as well as both unrevised and revised figures for the previous period (2508, 2512, 2514); the weekly net change in Weekly Jobless Claims for the current period (2510); the forecast for the weekly net change in Weekly Jobless Claims for the current period (2506); and the difference between the forecast and current figures for the weekly net change in Weekly Jobless Claims for the current period (2516).

FIG. 26 shows the data elements for the economic indicator “Kansas City Federal Survey” event (2600) in accordance with one or more embodiments of the invention. The data elements associated with this economic indicator event include the Manufacturing Index for the current and previous periods (2602, 2604).

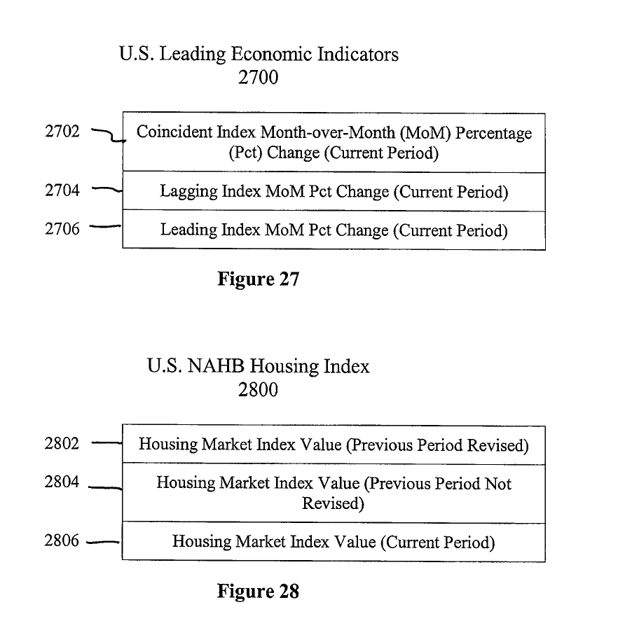

FIG. 27 shows the data elements for the economic indicator “U.S. Leading Economic Indicators” event (2700) in accordance with one or more embodiments of the invention. The data elements associated with this economic indicator event include the Month-over-Month Percentage Change in the Coincident Index for the current period (2702); the Month-over-Month Percentage Change in the Lagging Index for the current period (2704); and the Month-over-Month Percentage Change in the Leading Index for the current period (2706).

FIG. 28 shows the data elements for the economic indicator “U.S. NAHB Housing Index” event (2800) in accordance with one or more embodiments of the invention. The data elements associated with this economic indicator event include the Housing Market Index for the current period as well as both unrevised and revised figures for the previous periods (2802, 2804, 2806).

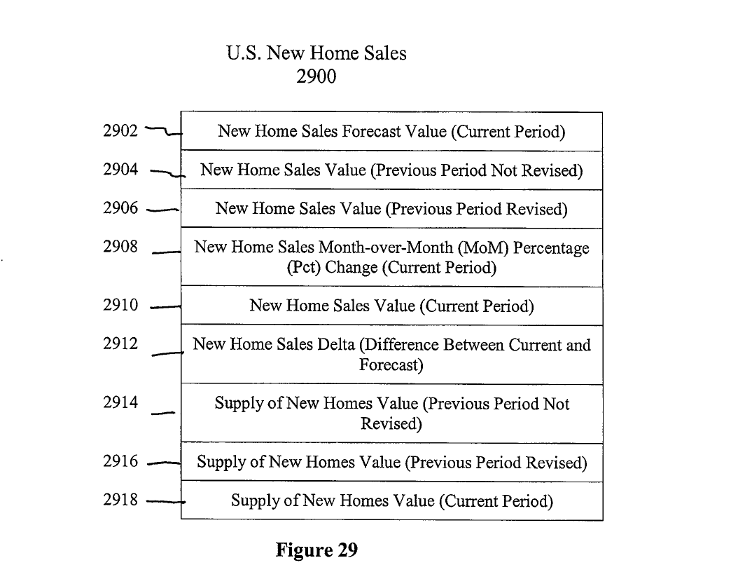

FIG. 29 shows the data elements for the economic indicator “U.S. New Home Sales” event (2900) in accordance with one or more embodiments of the invention. The data elements associated with this economic indicator event include New Home Sales for the current period as well as both unrevised and revised figures for the previous period (2904, 2906, 2910); the forecast for New Home Sales for the current period (2902); the difference between the forecast and current figures for New Home Sales for the current period (2912); the Month-over-Month Percentage Change in New Home Sales for the current period (2908); and the Supply of New Homes for the current period as well as both unrevised and revised figures for the previous period (2914, 2916, 2918).

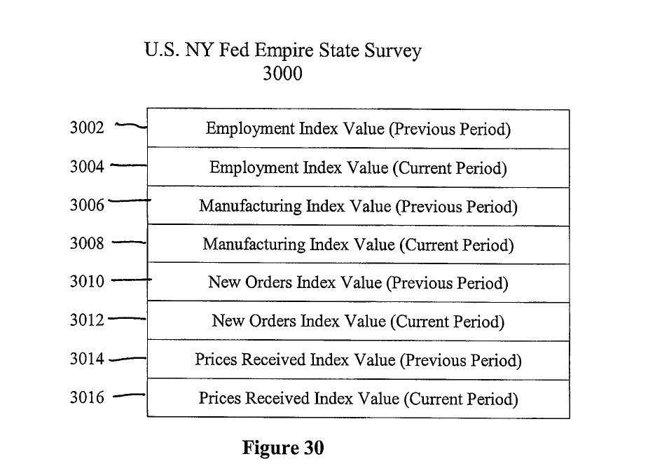

FIG. 30 shows the data elements for the economic indicator “U.S. NY Fed Empire State Survey” event (3000) in accordance with one or more embodiments of the invention. The data elements associated with this economic indicator event include the Employment Index for the current and previous periods (3002, 3004); the Manufacturing Index for the current and previous periods (3006, 3008); the New Orders Index for the current and previous periods (3010, 3012); and the Prices Received Index for the current and previous periods (3014, 3016).

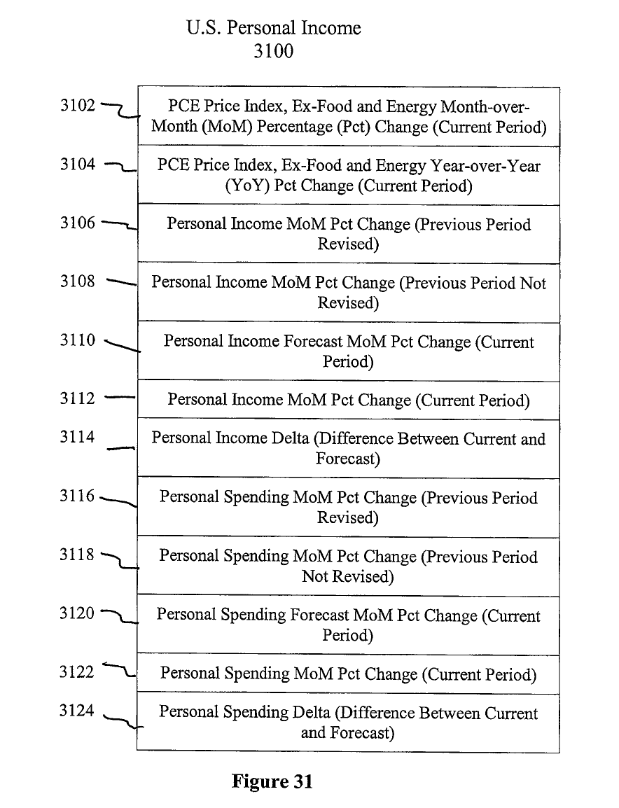

FIG. 31 shows the data elements for the economic indicator “U.S. Personal Income” event (3100) in accordance with one or more embodiments of the invention. The data elements associated with this economic indicator event include the Month-over-Month and Year-over-Year Percentage Change in the PCE Price Index, excluding Food and Energy, for the current period (3102, 3104); the Month-over-Month Percentage Change in Personal Income for the current period as well as both revised and unrevised figures for the previous period (3106, 3108, 3112); the forecast for the Month-over-Month Percentage Change in Personal Income for the current period (3110); the difference between the forecast and current figures for the Month-over-Month Percentage Change in Personal Income for the current period (3114); Month-over-Month Percentage Change in Personal Spending for the current period as well as both revised and unrevised figures for the previous period (3116, 3118, 3122); the forecast for the Month-over-Month Percentage Change in Personal Spending for the current period (3120); and the difference between the forecast and current figures for the Month-over-Month Percentage Change in Personal Spending for the current period (3124).

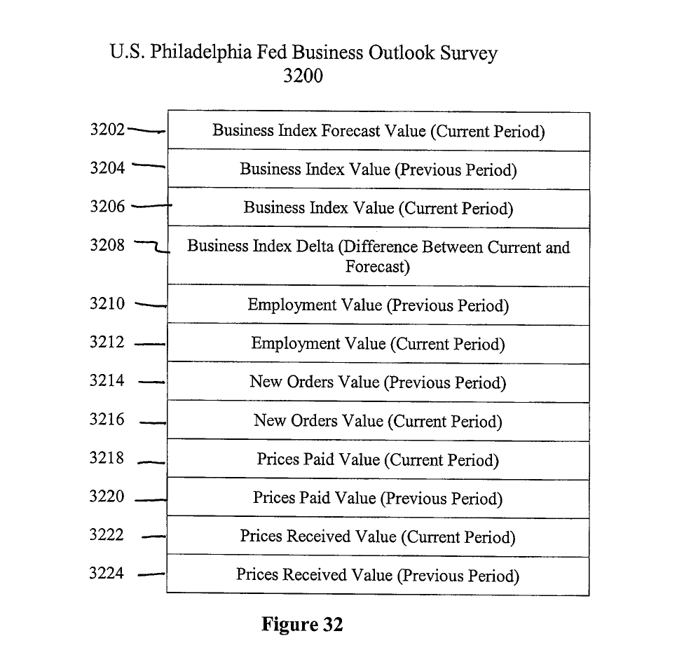

FIG. 32 shows the data elements for the economic indicator “Philadelphia Fed Business Outlook Survey” event (3200) in accordance with one or more embodiments of the invention. The data elements associated with this economic indicator event include the Business Index for the current and previous periods (3204, 3206); the forecast for the Business Index for the current period (3202); the difference between the forecast and current figures for the Business Index for the current period (3208); Employment for the current and previous periods (3210, 3212); New Orders for the current and previous periods (3214, 3216); Prices Paid the current and previous periods (3218, 3220); and Prices Received for the current and previous periods (3222, 3224).

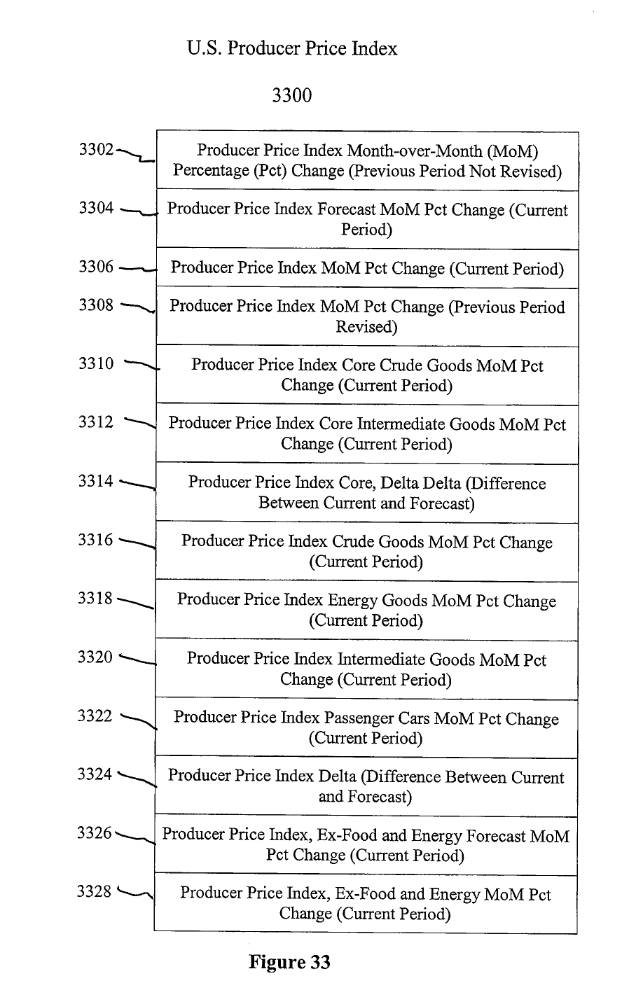

FIG. 33 shows the data elements for the economic indicator “U.S. Producer Price Index” event (3300) in accordance with one or more embodiments of the invention. The data elements associated with this economic indicator event include the Month-over-Month Percentage Change in the Producer Price Index for the current period as well as both unrevised and revised figures for the previous period (3302, 3306, 3308); the forecast for the Producer Price Index for the current period (3304); the Month-over-Month Percentage Change in the Producer Price Index Core Crude Goods for the current period (3310); the Month-over-Month Percentage Change in the Producer Price Index Core Intermediate Goods for the current period (3312); the Month-over-Month Percentage Change in the Producer Price Index Energy Goods for the current period (3318); the Month-over-Month Percentage Change in the Producer Price Index Passenger Cars for the current period (3322); the Month-over-Month Percentage Change in the Producer Price Index Intermediate Goods for the current period (3320); the forecast and current figures for the Month-over-Month Percentage Change in the Producer Price Index, excluding Food and Energy, for the current period (3326, 3328); the difference between the forecast and current figures for the Month-over-Month Percentage Change in the Producer Price Index, excluding Food and Energy, for the current period (3324); and the difference between the forecast and current figures for the Producer Price Index Core (3314).

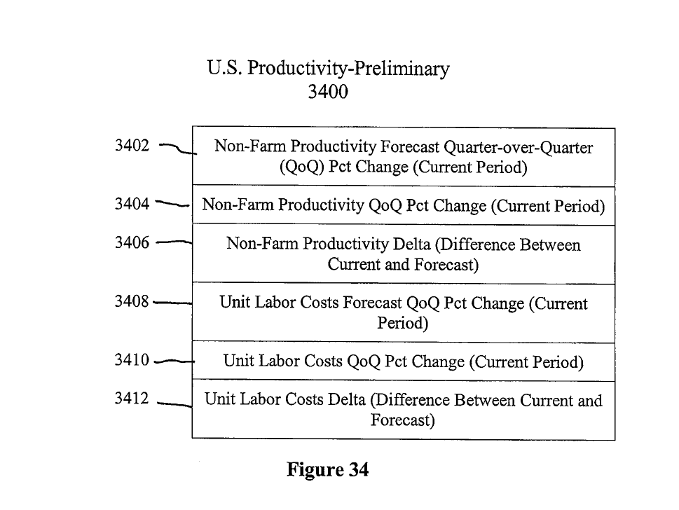

FIG. 34 shows the data elements for the economic indicator “U.S. Productivity—Preliminary” event (3400) in accordance with one or more embodiments of the invention. The data elements associated with this economic indicator event include the forecast and current figures for the Quarter-over-Quarter Percentage Change in Non-Farm Productivity for the current period (3402, 3404); the difference between the forecast and current figures for the Quarter-over-Quarter Percentage Change in Non-Farm Productivity for the current period (3406); the forecast and current figures for the Quarter-over-Quarter Percentage Change in Unit Labor Costs for the current period (3408, 3410); and the difference between the forecast and current figures for the Quarter-over-Quarter Percentage Change in Unit Labor Costs for the current period (3412).

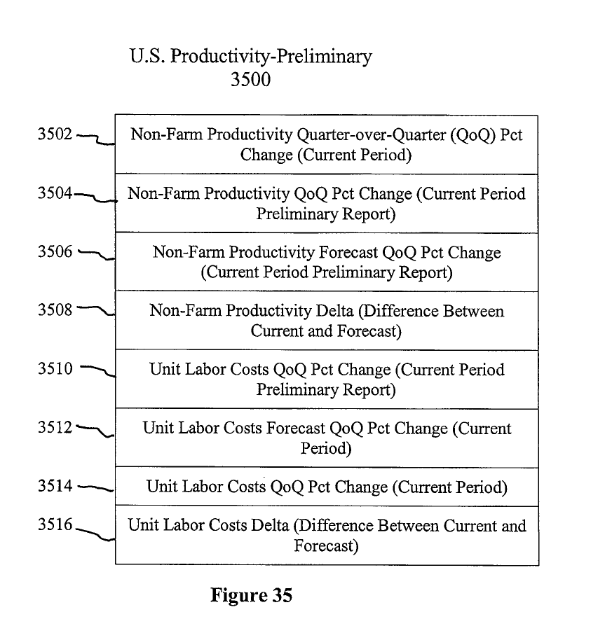

FIG. 35 shows the data elements for the economic indicator “U.S. Productivity—Revised” event (3500) in accordance with one or more embodiments of the invention. The data elements associated with this economic indicator event include the forecast and current figures for the Quarter-over-Quarter Percentage Change in Non-Farm Productivity for the current period, including a preliminary report for the current period (3502, 3504, 3506); the difference between the forecast and current figures for the Quarter-over-Quarter Percentage Change in Non-Farm Productivity for the current period (3508); the forecast and current figures for the Quarter-over-Quarter Percentage Change in Unit Labor Costs for the current period, including a preliminary report for the current period (3510, 3512, 3514); and the difference between the forecast and current figures for the Quarter-over-Quarter Percentage Change in Unit Labor Costs for the current period (3516).

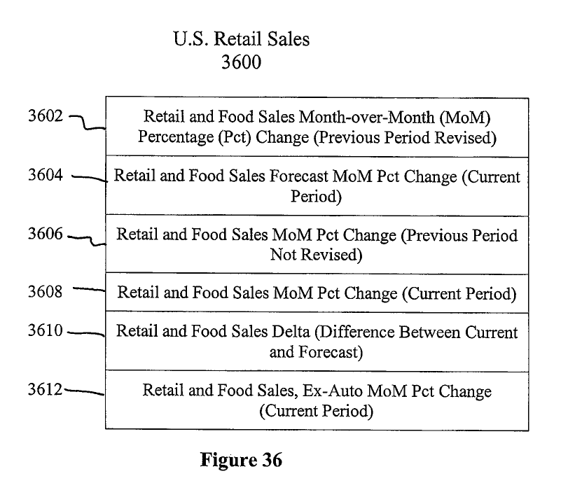

FIG. 36 shows the data elements for the economic indicator “U.S. Retail Sales” event (3600) in accordance with one or more embodiments of the invention. The data elements associated with this economic indicator event include the Month-over-Month Percentage Change in Retail and Food Sales for the current period and both unrevised and revised figures for the previous period (3602, 3606, 3608); the forecast for the Month-over-Month Percentage Change in Retail and Food Sales for the current period (3604); the difference between the forecast and current figures for the Month-over-Month Percentage Change in Retail and Food Sales for the current period (3610); and the Month-over-Month Percentage Change in Retail and Food Sales, excluding automobile sales, for the current period (3612).

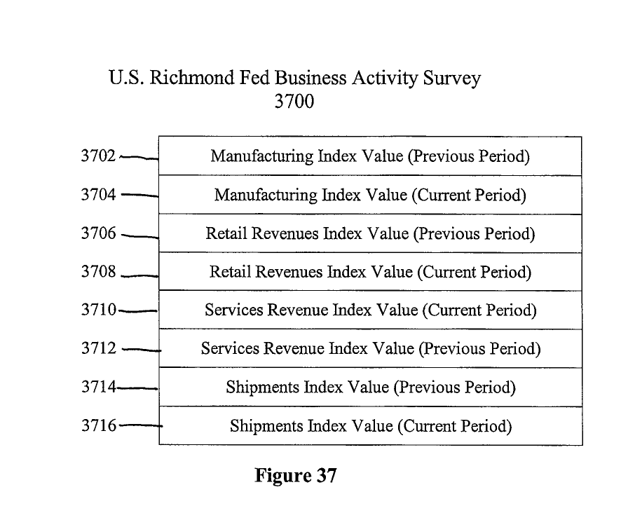

FIG. 37 shows the data elements for the economic indicator “Richmond Fed Business Activity Survey” event (3700) in accordance with one or more embodiments of the invention. The data elements associated with this economic indicator event include the Manufacturing Index for the current and previous periods (3702, 3704); the Retail Revenues Index for the current and previous periods (3706, 3708); the Services Revenue Index for the current and previous periods (3710, 3712); and the Shipments Index for the current and previous periods (3714, 3716).

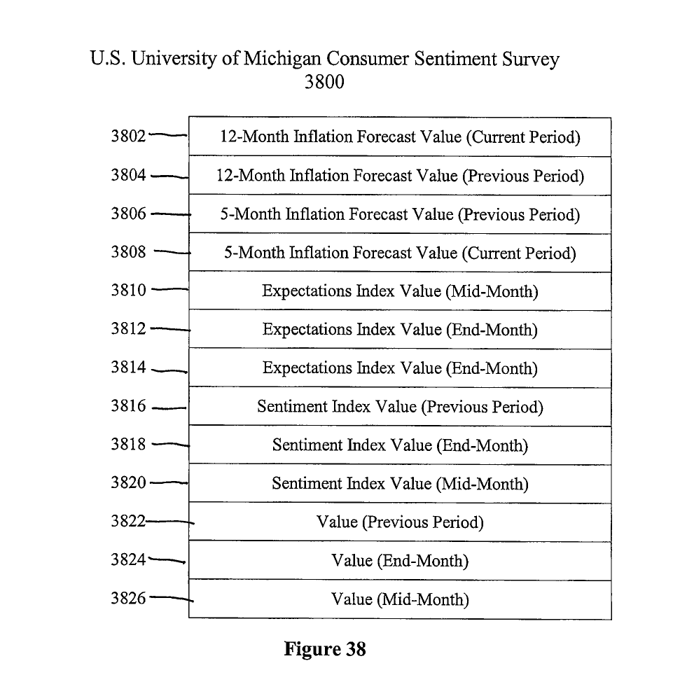

FIG. 38 shows the data elements for the economic indicator “University of Michigan Consumer Sentiment Survey” event (3800) in accordance with one or more embodiments of the invention. The data elements associated with this economic indicator event include the 12-Month Inflation Forecast for the current and previous periods (3802, 3804); the 5-Month Inflation Forecast for the current and previous periods (3806, 3808); the Expectations Index for the current and previous periods (3810, 3812, 3814); the Sentiment Index for the current and previous periods (3816, 3818, 3820); and the Value for the current and previous periods (3822, 3824, 3826).

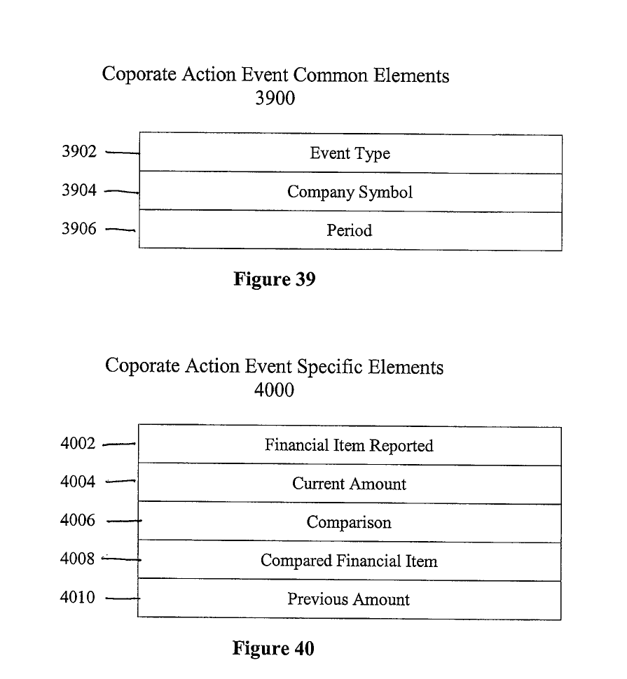

In addition to economic indicator events, certain corporate action events, such as corporate earnings reports or mergers and acquisitions, may generate news content of interest to investors. FIGS. 39 and 40 show data elements that may be associated with corporate action events.

FIG. 39 shows data elements (3900) common to corporate news messages in accordance with one more embodiments of the invention. Such elements may include the specific event type to be reported (3902), the symbol of the company at issue (3904), and the period for which information is reported (3906). It is expected that most or all news messages relating to corporate action events will include some or all of these data elements.

FIG. 40 shows the data elements for the corporate action news item category “earnings” (4000) in accordance with one or more embodiments of the invention. The corporate action news item category “earnings” represents an earnings report by a corporation. The data elements associated with such news items include the financial item reported (4002), such as earnings per share or profit/loss per share; the current value of that item (4004); a comparison value for the operator to report a comparison to a previous reported value (4006); a financial item for comparison with that reported (4008); and the previous amount reported for that compared financial item (4010).

Other corporate action events will have associated with them specific data elements of interest to traders in securities. Those relevant data elements will be predefined within the system so as to prompt the operator of the system to enter the data elements of interest.

Although the present invention has been described with reference to preferred embodiments, persons skilled in the art will recognize that changes may be made in form and detail without departing from the spirit and scope of the invention.

What is claimed is:

1. A process for providing machine-readable news content comprising:
selecting news content to provide;
entering elements of the selected news content into a computer file via a graphical user interface;
using a computer program to generate a news message in machine-readable format using the entered elements; and
electronically delivering the news message in machine-readable format to a potential user of such news content.

2. The process of claim 1, wherein the news content includes economic indicator data.

3. The process of claim 2, wherein the economic indicator data is United States Consumer Price Index information.

4. The process of claim 1, wherein the news message in machine-readable format is delivered by a low-latency feed.

5. The process of claim 1, further comprising adding metadata to the news message in machine-readable format.

6. The process of claim 5, wherein the metadata indicates the significance of the news content.

7. The process of claim 5, wherein the metadata indicates the age of the news content.

8. The process of claim 5, wherein the metadata indicates the schedule status of the news content.

9. The process of claim 5, wherein the metadata indicates the surprise status of the news content.

10. The process of claim 5, wherein the metadata identifies anomalous news content.

11. The process of claim 1, further comprising archiving the news message in machine-readable format.

12. A process for providing machine-readable news content comprising:
selecting news content to provide;
entering elements of the selected news content into a computer file via a graphical user interface;
using a computer program to generate a news message in machine-readable format using the entered elements;
using a computer program to generate a news message in free-text format using the entered elements;
delivering the news message in machine-readable format to potential users of such news content; and
delivering the news message in free-text format to potential users of such news content.

13. The process of claim 12, wherein the news content includes economic indicator data.

14. The process of claim 13, wherein the economic indicator data is United States Consumer Price Index information.

15. The process of claim 12, wherein the news message in machine-readable format is delivered by a low-latency feed.

16. The process of claim 12, further comprising adding metadata to the news message in machine-readable format.

17. The process of claim 16, wherein the metadata indicates the significance of the news content.

18. The process of claim 16, wherein the metadata indicates the age of the news content.

19. The process of claim 16, wherein the metadata indicates the schedule status of the news content.

20. The process of claim 16, wherein the metadata indicates the surprise status of the news content.

21. The process of claim 16, wherein the metadata identifies anomalous news content.

22. A system for providing machine-readable news content comprising:
a computer including a display and an input device;
a computer program capable of presenting a graphical user interface to an operator, such graphical user interface enabling the operator to enter elements of news content into a computer file;
a computer program capable of generating a news message in machine-readable format using the entered elements; and
means for electronically providing such news messages in machine-readable format to potential users.

23. The system of claim 22, wherein the computer program capable of generating a news message in machine-readable format is also capable of generating a news message in free-text format using the entered elements.

24. The system of claim 23 further comprising means for electronically providing such news messages in free-text format to potential users.

25. A computerized method for delivering machine readable news, comprising:
receiving news content at a computer;
generating a news message in machine readable format based at least in part on the received news content; and
transmitting at least a portion of the generated news message in machine-readable format to a third party.

26. The method of claim 25, further comprising adding metadata to the news message in machine-readable format to signify a level of importance to the news.

27. The method of claim 26, wherein the act of adding metadata to the news message in machine-readable format to signify a level of importance comprises adding data that identifies the news content as at least one of high, medium, low, or don't know the significance.

28. Software for delivering news message in machine-readable format, comprising:
computer instructions configured to cause a computer to receive news content;
computer instructions configured to cause a computer to generate a news message in machine-readable format based at least in part on the received news content; and
means for transmitting at least a portion of the generated news message in machine-readable format to a third party.

29. The software of claim 28, wherein the means for transmitting is a low-latency feed.

30. The software of claim 28, wherein the means for transmitting is a network feed.

31. The software of claim 28, further comprising computer instructions configured to cause a computer to receive data indicating a significance of at least a portion of the received news content.

32. The software of claim 31, wherein the data indicating significance of at least a portion of the received news content comprises a metatag indicating the significance as at least one of high, medium, low, and don't know.

33. Software for delivering news message in machine-readable format, comprising:
computer instructions configured to cause a computer to receive news content;
computer instructions configured to cause a computer to generate a news message in machine-readable format based at least in part on the received news content; and
computer instructions configured to cause a computer to transmit at least a portion of the generated machine readable news to a third party.

34. A process for providing machine-readable news content comprising:
a graphical user interface receiving news content from an operator;
the graphical user interface generating a news message in machine-readable format upon receiving an instruction from the operator; and
electronically delivering the news message in machine-readable format to a potential user of such news content.
